(19) United States
(12) Patent Application Publication
(10) Pub. No.: US 2018/0222594 A1
(43) Pub. Date: Aug. 9, 2018

(54) CANOPY, IN PARTICULAR FOR A PARAGLIDER, PARACHUTE, FLEXKITE, OR SURFKITE CANOPY

(71) Applicant: SWING FLUGSPORTGERÄTE GMBH, Landsberied (DE)

(72) Inventor: Michael Nesler, Tiers (IT)

(21) Appl. No.: 15/749,567

(22) PCT Filed: Jul. 27, 2016
(86) PCT No.: PCT/EP2016/001300

§ 371 Date: Feb. 1, 2018

(30) Foreign Application Priority Data
Aug. 4, 2015 (DE) 20 2015 005 513.3

(51) Int. Cl. B64D 17/18

(52) U.S. Cl. CPC B64D 17/18; B64D 17/12

(57) ABSTRACT

The invention relates to a canopy, in particular for a paraglider, parachute, flexkite, or surfkite, comprising an upper sail and a lower sail as well as profile-forming ribs, characterized in that at least two different zones are formed in the canopy that have different opening and emptying times.

The invention relates to a canopy, in particular for a paraglider, parachute, flexkite, or surfkite, comprising an upper sail and a lower sail as well as profile-forming ribs.

The canopy in accordance with the present invention should relate to any desired canopies such as are used in paragliders, parachutes, flexkites or surfkites. Corresponding canopies for models, that is for parachute models, flexkite models, etc., for example, should also be included. Pulling sails for ships and kites for high energy acquisition and also canopies used in sailboats such as have become known under the name parasailor are included in the same manner.

The term canopy, for example in a paraglider, is as a rule used as an umbrella term for the complete piece of equipment, that is, for example, the equipment of the paraglider that essentially comprises a canopy, for example the paraglider canopy, that is connected by lines to the harness receiving the pilot. The canopy has a respective two-layer airfoil that is divided into an upper sail and a lower sail and is frequently produced from a nylon material. Perpendicular ribs that divide the total inner space of the canopy into a plurality of chambers disposed in parallel with one another in the direction of flight are incorporated between the upper sail and the lower sail to create the profile of the canopy.

Ideal flight properties or an ideal lift generation is adopted on a generation of a profile of the canopy similar to an airfoil. One or more inlet openings are arranged at the front edge of the canopy, also called the leading edge, and air moves via said inlet openings into the interior of the canopy and is accumulated there. The resulting excess pressure in the interior of the chamber provides the desired profile creation of the paraglider.

The chambers shaped in the direction of flight of the currently used paraglider canopies and parachute canopies are continuously filled via the front intake openings using the ram pressure principle in the opening and flight phases to generate an aerodynamically favorable profile shape. When the canopy is raised in the start phase, in particular with little headwind, the filling process up to the forming of a bearing profile in the zenith is particularly critical. On the one hand, the generation of the required ram pressure (forward speed) by the active arm movement and running movement of the pilot requires a high effort. On the other hand, the asymmetrical profile generates a buckling torque that often leads to so-called sail overshoot and thus to the aborting of the start.

In the flight phase of paragliders, so-called collapsing of the paraglider sail caused by turbulence is particularly critical. In this process, the inner pressure of the double sail collapses over wide areas and loses its aerodynamic lift function. The refilling of the chambers requires a lot of time and generates a high loss of up to 100 m. This phase is characterized by a high fall velocity and a tendency to rotate. This phase corresponds to the opening procedure of a parachute. The swing tendency during the opening phase is particularly critical here. In some emergency situations, the pilot or the canopy is no longer able to reactivate the filling procedure or to end the rotation so that serious accidents cannot be precluded.

It is the object of the present invention to further develop a canopy of the category such that critical situations in flight are largely avoided.

This object is achieved in accordance with the invention by the combination of the features of claim 1. For this purpose, a canopy that comprises an upper sail and a lower sail and ribs forming a profile is further developed such that at least two separate pressure zones are formed in the canopy that have different opening and emptying sides.

In accordance with the invention, a filling and emptying of the canopy optimized for the flight phase is made possible by the provision of the two separate pressure zones within the canopy that have different opening and emptying times. A control and extreme improvement of the aerodynamic properties of the canopy with respect to the physics of flight is thus provided in abnormal flight phases, on the raising of the canopy, on the start, and on the opening of the canopy. As a result borderline situations are defused, the height loss in the event of a disturbance, and the effort on the raising are substantially reduced, the filling phase up to the lift phase is decisively cut and the overshoot of the canopy on the starting procedure or the swinging of a parachute are prevented.

Further preferred aspects of the invention result from the dependent claims following on from the main claim.

The pressure zones are advantageously formed by cells.

The cells are advantageously formed by transverse ribs that enable an air exchange between the pressure zones.

The air exchange between the pressure zones can advantageously take place through openings and/or valves in the transverse ribs.

The air exchange between the pressure zones can be set by the dimensioning of the openings and/or valves such that different opening and closing times result in the cells.

Alternatively, the two or more pressure zones can also be separated from one another in an airtight manner; the transverse ribs accordingly mutually seal the cells/pressure zones. In this case the ventilation/venting of the pressure zones preferably takes place via separate openings and/or valves through which air can flow from the outside into the pressure zone or through which air can escape. The separate openings and/or valves are ideally dimensioned such that different opening and emptying times result for the pressure zones/cells.

The cells disposed at the front in the direction of inflow are advantageously filled faster than the rear cells during the filling. It is hereby prevented, in particular at the start, that a paraglider canopy overshoots, for example. Furthermore, no leveraging takes place and a smaller effort is required for raising.

In accordance with a further advantageous aspect of the invention, the cells disposed at the rear in the direction of inflow are emptied more slowly than the front cells during emptying. A higher buckling stiffness of the total canopy is hereby reached. No rotation or only very slight rotation after collapse takes place. The reopening of the canopy is substantially accelerated. Finally, the height loss is substantially reduced.

The invention finally relates to a paraglider, parachute, flexkite, or surfkite comprising a canopy that comprises the aforesaid features.

Further features, details and advantages of the invention will be explained in more detail with reference to an embodiment shown in the drawing.

There are shown:

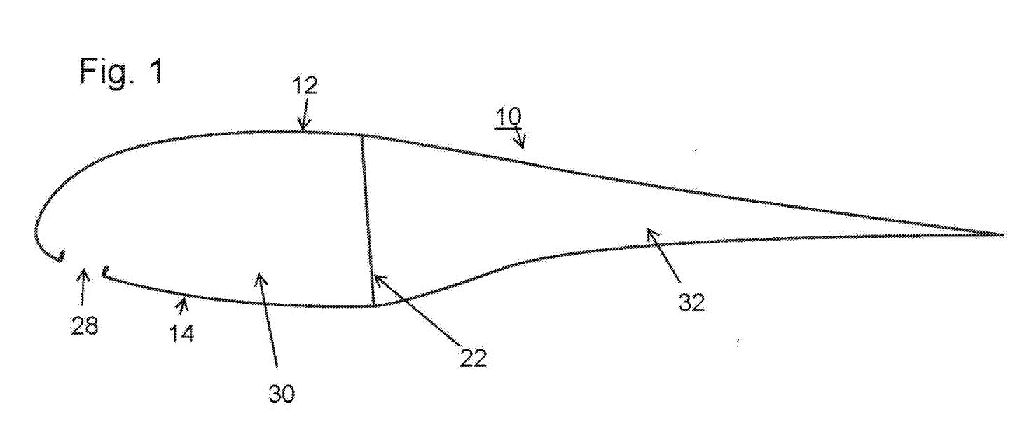

FIG. 1: a schematic cross-section through a canopy in accordance with a first embodiment of the present invention in the filling phase;

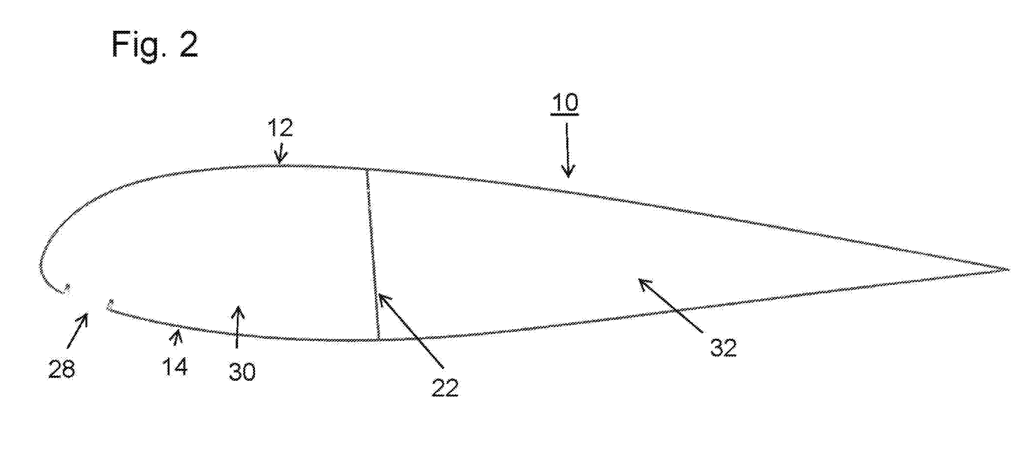

FIG. 2: a representation of the canopy of FIG. 1 in normal flight;

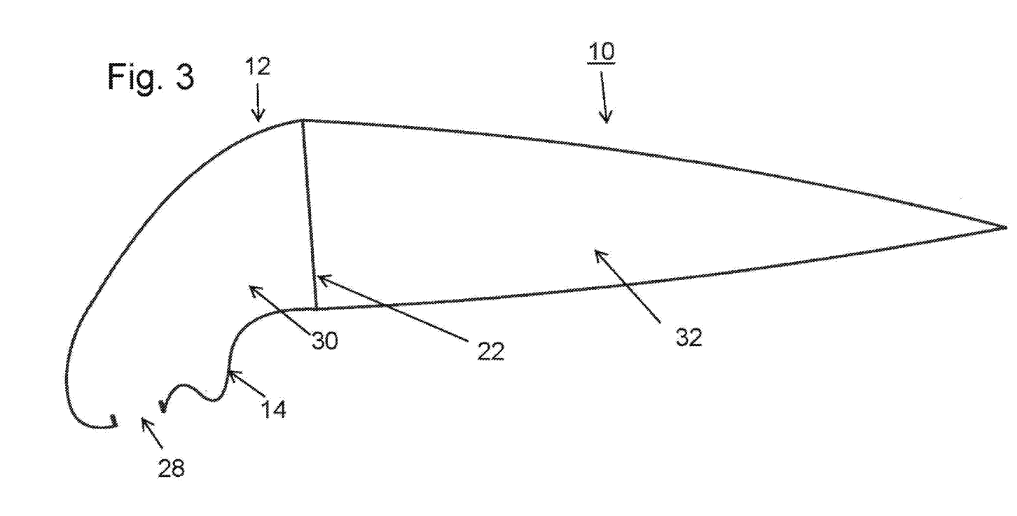

FIG. 3: a canopy of FIGS. 1 and 2 with a disturbance in flight;

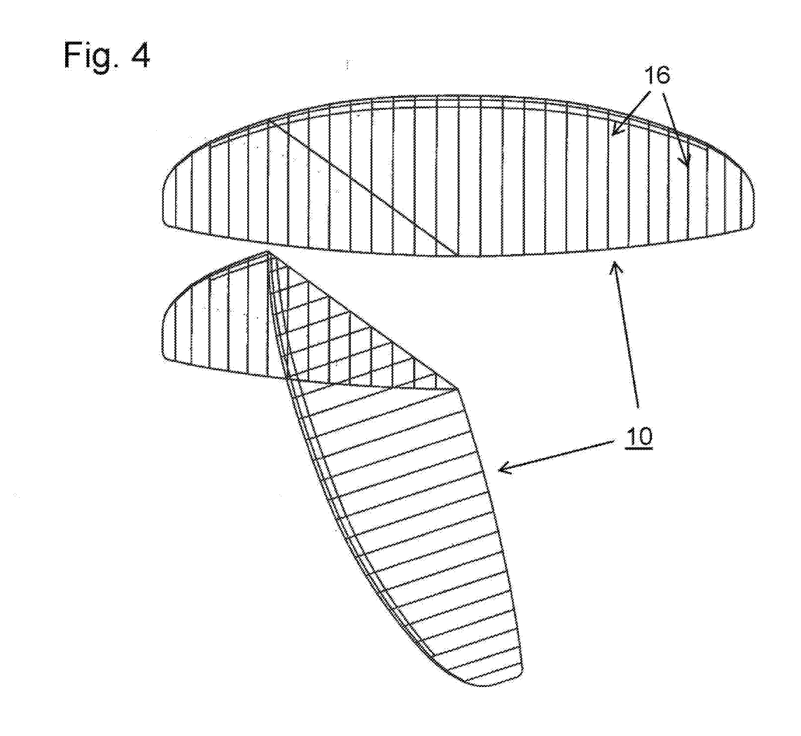

FIG. 4: a plan view of a conventional paraglider during the flight phase and with a deformed surface;

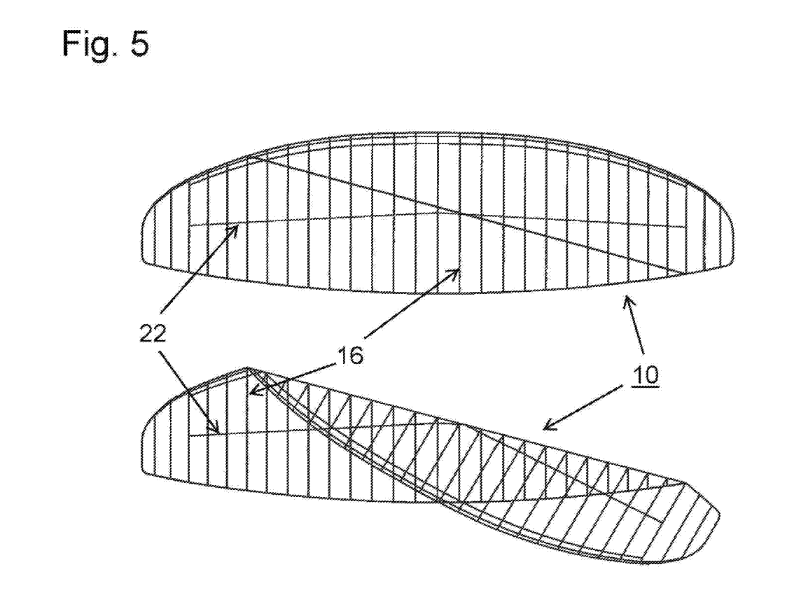

FIG. 5: the representation of FIG. 4, but here with a canopy in accordance with the invention;

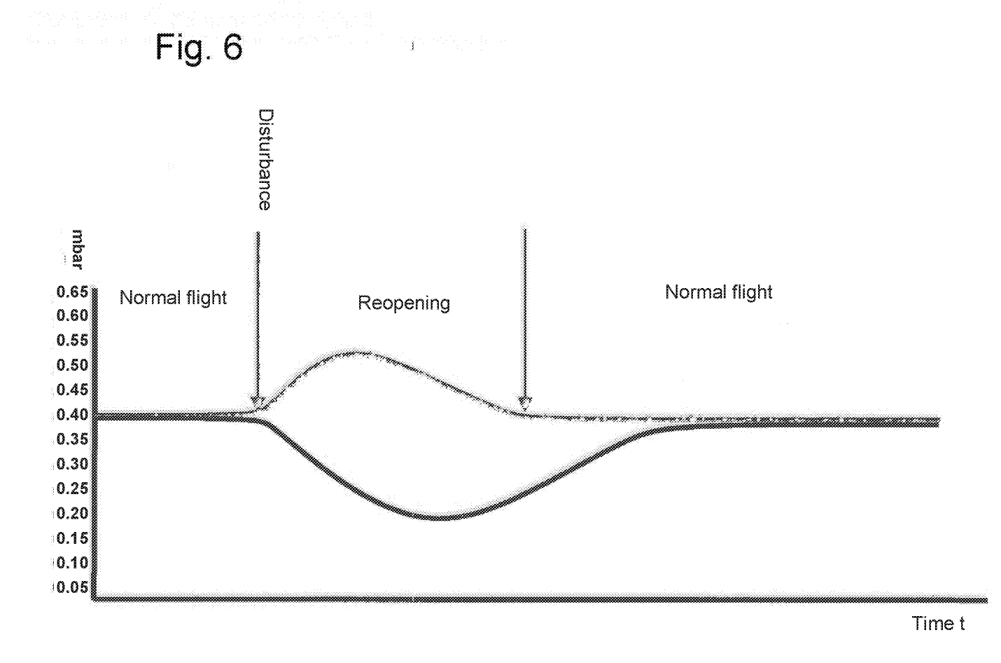

FIG. 6: the pressure development of the inner pressure in the excess pressure range of a canopy in accordance with the invention and of a canopy in accordance with the prior art in comparison;

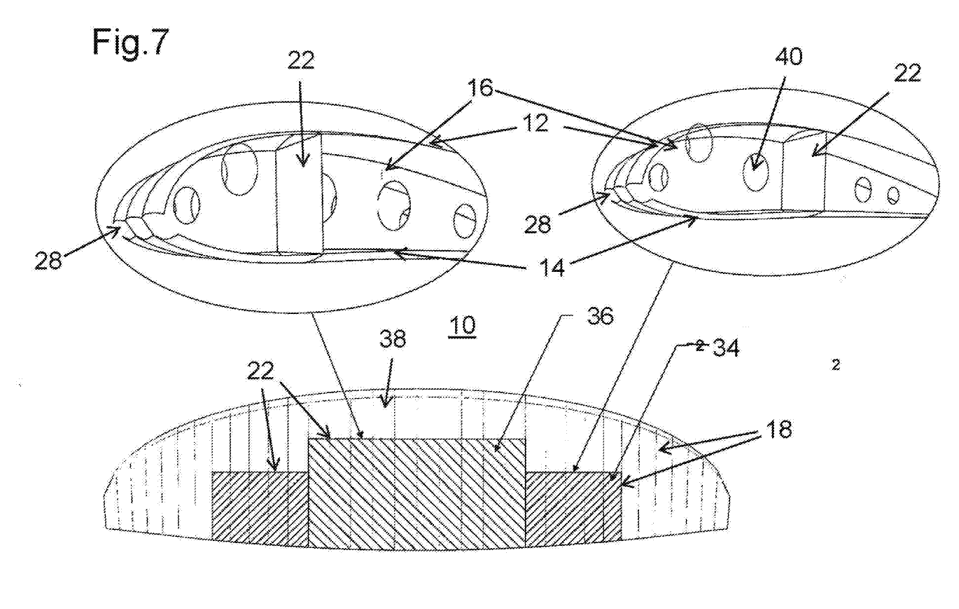

FIG. 7: a plan view and two partly sectioned views through a canopy in accordance with a second embodiment of the present invention; and

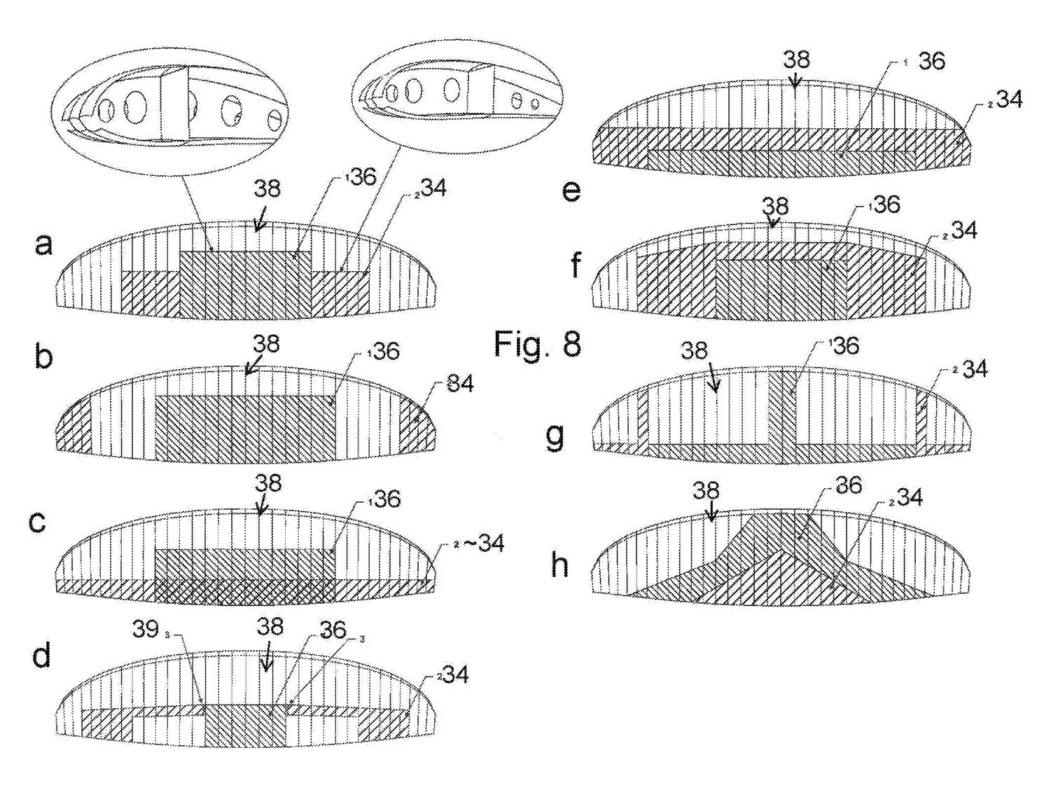

FIG. 8: eight different embodiments of canopies in accordance with the present invention.

FIG. 1 shows a schematic cross-section through a canopy 10 in its filling phase. The canopy 10 has an upper sail 12 and a lower sail 14. Not shown in section here are the ribs 16 forming the profile. They can, however, be recognized in the representations in accordance with FIG. 5 or 7. Two separate pressure zones 30 and 32 are formed by the provision of the transverse rib 22. The pressure zones 30 and 32 have different opening and emptying times. They are controlled both in the longitudinal direction and in the transverse direction by corresponding openings or valves not shown in any more detail in the representation. The inlet opening into the front pressure zone 30 is shown by 28. The air flows in here.

A canopy 10 is now shown during the start process in the filling phase in FIG. 1. It becomes particularly clear here that the different pressure zones 30 and 32 have different opening and closing times. The pressure zone 30 is already filled by the ram pressure that was built up via the inlet opening 28. The second pressure zone 32, in contrast, is not yet completely filled. A shaping of the canopy cross-section is hereby produced that is in particular advantageous for the start phase of a paraglider. No leveraging or overshooting takes place here and only a small effort is required for the pilot on the raising.

The cross-section of the canopy 10 in normal flight is shown in FIG. 2. The pressure zones 30 and 32 are filled here. The same pressure is present in both pressure zones. There is no difference from the customary systems in this situation.

FIG. 3 now shows the cross-section of the canopy 10 on a disturbance in the flight, for example on the occurrence of turbulence. It can be seen here that the first pressure zone 30 has already emptied while the second pressure zone 32 only empties with a delay and still has a sufficiently high stability at the point in time shown here so that the canopy 10 of a paraglider, for example, still has a sufficiently large bearing lift that results in a higher buckling stiffness of the canopy 10 and makes a rotation after collapse more difficult or largely prevents it. The reopening of the canopy can also be accelerated and the pilot loses less height when dropping during the disturbance.

The corresponding buckling behavior of a canopy is shown in a conventional embodiment in FIG. 4. The collapse line and the deformed surface with conventional paragliders 10 are shown here.

In comparison with this, the collapse line and the deformed surface in the system in accordance with the invention are shown in FIG. 5.

A higher buckling stability is here achieved by the two pressure zones and by the cells hereby formed that results in more stable flight characteristics on this disturbance.

The inner pressure progression of a conventional canopy 10 of a traditional paraglider over time (bottom curve) is compared with the inner pressure progression of a canopy 10 in accordance with the invention in FIG. 6. Whereas the same pressure conditions apply in normal flight, a higher inner pressure is shown in the reopening phase for the canopy 10 in accordance with the present invention on the disturbance, which produces a faster filling and thus a faster stability of the canopy.

It can initially be recognized in the plan view in FIG. 7 that different cells are formed here. These cells 34, 36, and 38 here form the different pressure zones that are separated from one another via transverse ribs 22 and by the ribs 16 forming the profile. Openings/valves for the air exchange can be seen in the region of the connection point of the transverse ribs 22 to the upper and lower sails 12, 14. The ribs 16 are, however, closed or only have small openings or valves between the ribs within a chamber 34, 36, or 38. The respective openings and valves are selected here such that different opening and closing times result in the different pressure zones, i.e. zones 34, 36, and 38.

Different arrangements for the separate pressure zones 34, 36, 38, and 39 are now shown in FIG. 8 that are here naturally also shown only by way of example. The flight characteristics of the canopy 10 can be optimized as desired by these different pressure zones or regions 34, 36, 38, and 39.

Alternatively to the embodiment shown, the individual pressure zones 30, 32 could also be closed in an airtight manner with respect to one another, i.e. the transverse ribs 22 and/or the ribs do not provide any openings/valves for the air exchange. A separate inlet opening would have to be provided for ventilation/venting the pressure zone 32 in this case, said inlet opening being introduced, for example, just behind the transverse rib 22 at the lower sail 14 in the direction of inflow. The previously mentioned flight characteristics are achieved by suitable dimensioning of the two inlet openings.

1. A canopy (10), in particular for a paraglider, parachute, flexkite, or surfkite, comprising an upper sail (12) and a lower sail (14), and ribs (16) forming a profile, wherein
at least two separate pressure zones (30, 32) are formed in the canopy (10) that have different opening and emptying times.

2. A canopy (10) in accordance with claim 1, wherein the pressure zones are formed by cells.

3. A canopy (10) in accordance with claim 2, wherein the cells are formed by transverse ribs (22) that enable an air exchange between the pressure zones.

4. A canopy (10) in accordance with claim 3, wherein the air exchange between the pressure zones takes place through openings in the transverse ribs (22).

5. A canopy (10) accordance with claim 3, wherein the air exchange between the pressure zones takes place through valves in the transverse ribs (22).

6. A canopy (10) in accordance with claim 1, wherein the air exchange between the pressure zones is adjustable by the dimensioning of the openings and/or valves such that different opening and emptying times result in the cells.

7. A canopy (10) in accordance with claim 2, wherein at least two separate pressure zones/cells are closed in an airtight manner with respect to one another and the at least two pressure zones are ventilated and/or vented through separate openings and/or valves, with the separate openings and/or valves being dimensioned such that different opening and emptying times result in the pressure zones/cells.

8. A canopy (10) in accordance with claim 6, wherein the cells disposed at the front in the direction of inflow are filled faster than the rear cells on the filling.

9. A canopy (10) in accordance with claim 1, wherein the cells disposed at the rear in the direction of inflow are emptied more slowly than the front cells on the emptying.

10. A paraglider, parachute, flexkite, or surfkite having a canopy in accordance with claim 1.

11. A canopy (10) in accordance with claim 5, wherein the air exchange between the pressure zones is adjustable by the dimensioning of the openings and/or valves such that different opening and emptying times result in the cells.

12. A canopy (10) in accordance with claim 4, wherein the air exchange between the pressure zones is adjustable by the dimensioning of the openings and/or valves such that different opening and emptying times result in the cells.

13. A canopy (10) in accordance with claim 3, wherein the air exchange between the pressure zones is adjustable by the dimensioning of the openings and/or valves such that different opening and emptying times result in the cells.

14. A canopy (10) in accordance with claim 2, wherein the air exchange between the pressure zones is adjustable by the dimensioning of the openings and/or valves such that different opening and emptying times result in the cells.

15. A canopy (10) in accordance with claim 14, wherein the cells disposed at the front in the direction of inflow are filled faster than the rear cells on the filling.

16. A canopy (10) in accordance with claim 13, wherein the cells disposed at the front in the direction of inflow are filled faster than the rear cells on the filling.

17. A canopy (10) in accordance with claim 12, wherein the cells disposed at the front in the direction of inflow are filled faster than the rear cells on the filling.

18. A canopy (10) in accordance with claim 11, wherein the cells disposed at the front in the direction of inflow are filled faster than the rear cells on the filling.

19. A canopy (10) in accordance with claim 7, wherein the cells disposed at the front in the direction of inflow are filled faster than the rear cells on the filling.

20. A canopy (10) in accordance with claim 19, wherein the cells disposed at the rear in the direction of inflow are emptied more slowly than the front cells on the emptying.
